(19) United States
(12) Patent Application Publication
(10) Pub. No.: US 2019/0050436 A1
(43) Pub. Date: Feb. 14, 2019

(54) CONTENT-BASED PREDICTIVE ORGANIZATION OF COLUMN FAMILIES

(71) Applicant: INTERNATIONAL BUSINESS MACHINES CORPORATION, ARMONK, NY (US)

(72) Inventors: Umesh Deshpande, San Jose, CA (US); Paul H. Muench, San Jose, CA (US); Mohit Saxena, San Jose, CA (US); Sangeetha Seshadri, San Jose, CA (US)

(21) Appl. No.: 15/675,838

(22) Filed: Aug. 14, 2017

(51) Int. Cl. G06F 17/30

(52) U.S. Cl. CPC G06F 17/30321; G06F 17/30569; G06F 17/30235; G06F 17/30303; G06F 2009/4557; G06F 17/30339; G06F 17/30578; G06F 17/30575; G06F 17/30566; G06F 17/30315

(57) ABSTRACT

A method, computer system, and a computer program product for organizing a plurality of column families based on data content is provided. The present invention may include analyzing a plurality of data. The present invention may also include generating a plurality of individual columns based on the analyzed plurality of data. The present invention may then include identifying a plurality of temporal access patterns associated with the generated plurality of individual columns based on the content of the analyzed plurality of data. The present invention may further include forming the plurality of column families based on the identified plurality of temporal access patterns. The present invention may also include storing the formed plurality of column families in a key-value store.

### BACKGROUND

The present invention relates generally to the field of computing, and more particularly to data processing.

In key-value stores, the fields of the value may be placed contiguously in storage. Although this placement allows the fields to be read in a single read operation, the fields not required by the application may also be unnecessarily read from the storage, and therefore, pollute the application cache. In contrast, in column-based stores each field of a value is stored as separate columns. However, when several columns are accessed together, the columns may be separately read from storage after a query is requested. As a result, multiple read operations may be utilized, which increases read latency.

### SUMMARY

Embodiments of the present invention disclose a method, computer system, and a computer program product for organizing a plurality of column families based on data content. The present invention may include analyzing a plurality of data. The present invention may also include generating a plurality of individual columns based on the analyzed plurality of data. The present invention may then include identifying a plurality of temporal access patterns associated with the generated plurality of individual columns based on the content of the analyzed plurality of data. The present invention may further include forming the plurality of column families based on the identified plurality of temporal access patterns. The present invention may also include storing the formed plurality of column families in a key-value store.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for reactive identification of column families according to at least one embodiment;

FIG. 3 is a diagram of the temporal access pattern of dynamic column families according to at least one embodiment;

FIG. 4 is an operational flowchart illustrating a process for proactive identification of column families according to at least one embodiment;

FIG. 5 is a diagram of the temporal access pattern of ephemeral column families according to at least one embodiment;

FIG. 6 is an operational flowchart illustrating a process for storing and indexing column families according to at least one embodiment;

FIG. 7 is a diagram illustrating an exemplary process for creating an ephemeral index for column families according to at least one embodiment;

FIG. 8 is a diagram illustrating an exemplary process for creating an ephemeral index for column families related to motion and light sensors for a smart home monitoring system according to at least one embodiment;

FIG. 9 is a block diagram of internal and external components of computers and servers depicted in FIG. 1 according to at least one embodiment;

FIG. 10 is a block diagram of an illustrative cloud computing environment including the computer system depicted in FIG. 1, in accordance with an embodiment of the present disclosure; and

FIG. 11 is a block diagram of functional layers of the illustrative cloud computing environment of FIG. 10, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for organizing column families based on data content. As such, the present embodiment has the capacity to improve the technical field of data processing by utilizing temporal access patterns of data or the predictive content of data to form column families, and organizing these column families into ephemeral indexes for a specific time-period. More specifically, by either identifying temporal access patterns of input data or detecting a distinct content pattern for incoming data, the column-based organization program may form column families that serve future queries for data during a certain time window. After the expiration of that time window, the column families may be dissolved to reduce cache pollution (e.g., a situation where an executing computer program loads data into the CPU cache unnecessarily causing other useful data to be evicted from the cache into lower levels of the memory hierarchy, degrading performance), reduce resource usage, and increase output retrieval speed. Prior to the dissolution, the individual columns may be stored in the key-value store in which the individual columns create index entries that may be added to an ephemeral index.

As described previously, in key-value stores, the fields of the value may be placed contiguously in storage. Although this placement allows the fields to be read in a single read operation, the fields not required by the application may also be unnecessarily read from the storage, and therefore, pollute the application cache. In contrast, in column-based stores each field of a value is stored as separate columns. However, when several columns are accessed together, the columns may be separately read from storage after a query is requested. As a result, multiple read operations may be utilized, which increases read latency.

Therefore, it may be advantageous to, among other things, store each field as a separate column to allow separate readability. Additionally, storing related columns together allows the column-based organization program to read multiple columns in a single read operation. Since the fields of the column families are also pre-fetched in a single read operation, the subsequently accessed fields may not be read individually from the storage, thus reducing the latency and increasing efficiency while generating a quicker output and using less resources.

According to at least one embodiment, the correlation between the columns may be transient, even though the formation of column families allows simultaneous access to the related columns. In non-structured query language (NoSQL) key-value stores, the queries may depend on the content pattern of one of the fields in the value. For instance, increase in temperature of a machine may result in queries that access the fields associated with vibration or noise levels of the machine. When unrelated columns are stored together, several column families may have to be accessed for the desired columns to a query, which may cause cache pollution. Additionally, the latency introduced from searching for multiple column families may degrade the performance of the application, and offset the benefits of forming column families. A column may be further correlated with other-related columns, which may further complicate the formation of column families.

According to at least one embodiment, instead of creating column families within storage, the column-based organization program may create ephemeral column families to reflect the temporal access correlation between different columns. An ephemeral column family may be a logical association of columns that may be accessed together. Each column of the column family may be placed separately within storage; however, each column may be correlated by accesses or access requests (e.g., a read access to columns in the column family may also trigger read accesses for the other columns of the same column family, allowing all the correlated fields to be pre-fetched). Additionally, the ephemeral column families may be dynamically formed and dissolved leading to the reorganization of the columns into column families, according to their changing temporal access patterns over time.

According to at least one embodiment, the ephemeral indexes may be created from the indexes of the individual columns. The index may include a key and the location of the corresponding value in storage. The ephemeral index may include mapping from key to location of multiple values belonging to different columns. The ephemeral index may be constructed prior to the expected access of the member columns in the ephemeral index. After construction, column searches may be conducted through the ephemeral index, instead of through their dedicated indexes, which may eliminate a separate search of other correlated columns and allows for pre-fetching in the memory. As long as the given correlation persists, newer nodes may be added to the ephemeral index and the older nodes that are beyond the predicted access time interval may be removed.

According to at least one embodiment, the use of ephemeral column families may assume that the existing data records in storage are not updated; however, new records may be added. Therefore, for the addition of new records, only individual column indexes may be updated, whereas the ephemeral index may be allowed to lag behind the dedicated column indexes. Upon failing to find a newly inserted record in the ephemeral index, the individual indexes may be searched.

According to at least one embodiment, the creation of an ephemeral index may include the traversal of individual column indexes. The ephemeral index may occupy as much memory as their column indexes. However, the size of some of the fields may be small enough that the CPU and memory overhead for generating ephemeral indexes outweighs the space overhead for simply replicating and storing them with the correlated columns. Therefore, for small field size columns, instead of generating an ephemeral column family, the column-based organization program may create permanent column families within storage by replicating the permanent column families with other correlated columns. Also, for a small field size, the extent of cache pollution may be reduced since the grouping of unrelated columns may not be notable. The minimum size limit for a column to be considered for an ephemeral column family may depend on the size of the ephemeral index and the available memory on the node.

According to at least one embodiment, the column-based organization program may predictively form the families of the columns that are accessed together even before the data is written in storage (i.e., proactive identification of column families). The columns in a column family may be indexed and stored together, and the related columns may be searched and read in a single operation reducing the read latency. The composition of column families may vary for different intervals, since the column families may be formed based on the data content pattern. The organization of column families in storage may also change over time. Therefore, the column-based organization program may maintain a mapping between a time window and the corresponding column family organization.

According to at least one embodiment, with the proactive identification of column families, a change in the content pattern may result in a change in the queries that are executed on that data. Known pattern detection clustering algorithms may be utilized to identify interesting data content patterns. For each pattern, the column-based organization program may track the conditional probability of the given column access pattern for a specific interval. When the conditional probability exceeds a pre-defined threshold, the column-based organization program may establish a correlation between the pattern and the tracked column family.

According to at least one embodiment, the use of ephemeral indexes may create more efficiency when searching for the location of different fields of data. Additionally, the use of ephemeral indexes may reduce cache pollution, since large volumes of data unrelated to a received query may be stored in one location. If, however, data and the respective columns are stored in separate indexes based on similarities (e.g., access and time window), then there may be less cache pollution and easier retrieval of data for a received query.

According to at least one embodiment, the column-based organization program may learn about the correlation between the columns based on the temporal access pattern of the input data received to identify the column families (i.e., reactive identification of column families). The proactive approach to identifying column families may utilize the correlation between the content pattern and access pattern of the data even before the data is written in the storage.

According to at least one embodiment, with the reactive identification of ephemeral column families, the column-based organization program may track the temporal locality of accesses for each column by plotting their accesses for each pattern detected in the incoming data. Then, the column-based organization program may utilize distinct clusters of overlapping ranges to form the ephemeral column families. The interval, which the input/output (I/O) bandwidth of the columns remains above a pre-defined threshold, may be considered the column family's life span. Since the column families are ephemeral, a column may become a part of several column families over time.

According to at least one embodiment, with the identification of dynamic column families, the column-based organization program may track the access of individual columns to find the co-localization of columns along the time line using an overlap coefficient. The disjoint set of columns having high overlap coefficient may be grouped into a column family, while the remaining columns may be stored individually.

In the present embodiment, although column families may be periodically dissolved based on time windows, the column families may be stored in the memory of a computer, or may exist independently in another mode of storage, for retrieval at a later time.

In the present embodiment, the column-based organization program may utilize time as the main factor to evaluate and analyze data. As such, the time that data arrives, the age of the data record, and the time windows according to the age of the records may be used to identify, form, track and dissolve column families and ephemeral indexes by the column-based organization program.

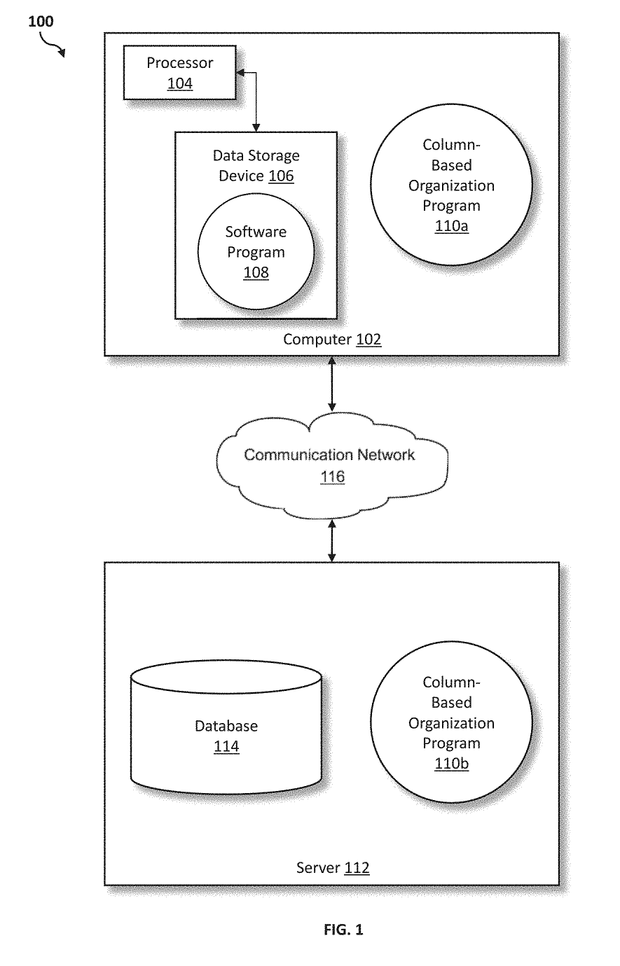

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a column-based organization program 110a. The networked computer environment 100 may also include a server 112 that is enabled to run a column-based organization program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

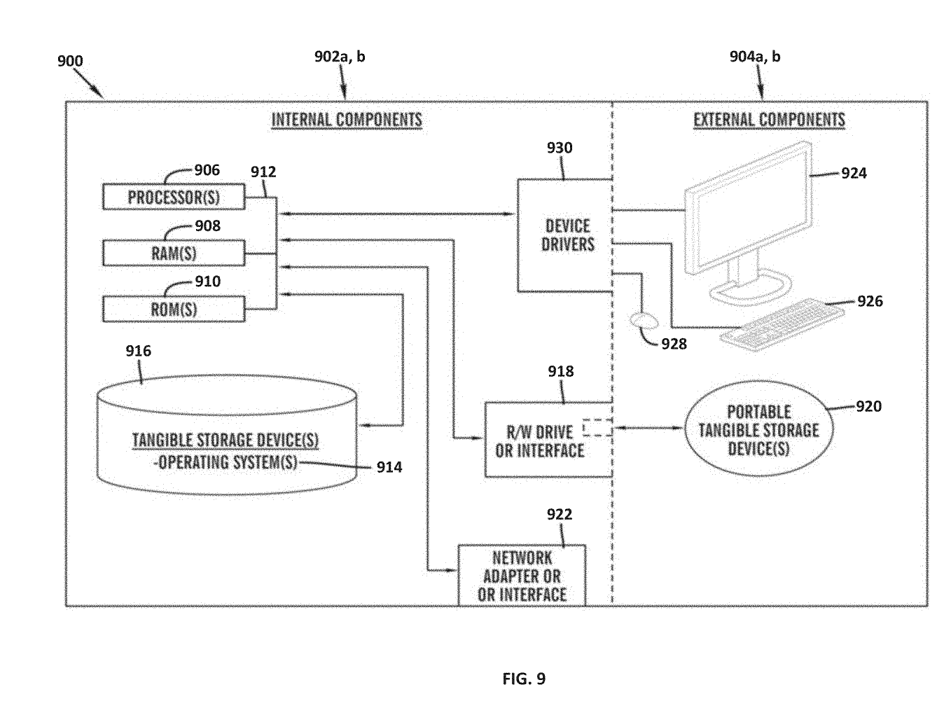

The client computer 102 may communicate with the server computer 112 via the communications network 116. The communications network 116 may include connections, such as wire, wireless communication links, or fiber optic cables. As will be discussed with reference to FIG. 9, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the column-based organization program 110a, 110b may interact with a database 114 that may be embedded in various storage devices, such as, but not limited to a computer/mobile device 102, a networked server 112, or a cloud storage service.

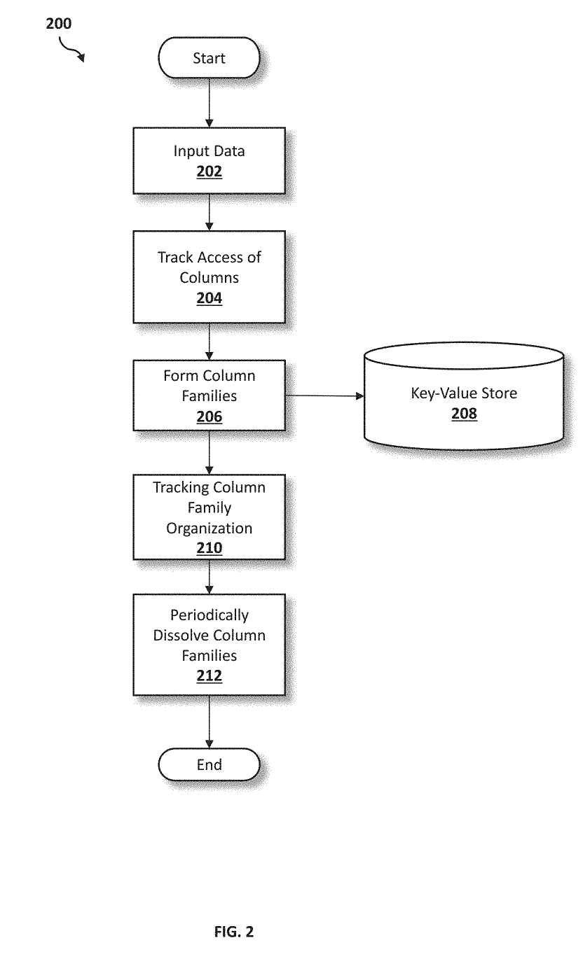

According to the present embodiment, a user using a client computer 102 or a server computer 112 may use the column-based organization program 110a, 110b (respectively) to organize column families based on content. The column-based organization method is explained in more detail below with respect to FIGS. 2-8.

Referring now to FIG. 2, an operational flowchart illustrating the exemplary reactive identification of column families process 200 used by the column-based organization program 110a and 110b according to at least one embodiment is depicted.

At 202, data arrives as input into the column-based organization program 110a, 110b. The input data may include information pertaining to an event (e.g., alarm system activation, or motion sensor deactivation) within a certain time window (e.g., from 1 pm to 2 pm). The data may be retrieved from various sources (e.g., user, an application, sensor systems, computing devices). Upon retrieval, the data may be uploaded or fed into the column-based organization program 110a, 110b by using a software program 108 on the user's device (e.g., user's computer 102) that transmits the input data via the communications network 116.

For example, an office elevator system utilizes a system of sensors to control the air quality, temperature and weight within the elevator. When a query for the elevator temperature is received by the column-based organization program 110a, 110b, the following queries are related to the air quality and the weight within the elevator. The data related to the temperature, air quality and elevator weight are transmitted from the elevator sensors to the column-based organization program 110a, 110b via the communications network 116.

Next, at 204, temporal access of individual columns is tracked by the column-based organization program 110a, 110b. Once the data is received by the column-based organization program 110a, 110b, each field of the data may be organized into individual columns. The temporal access of individual columns may be tracked by the column-based organization program 110a, 110b to establish the temporal correlation (e.g., two columns are temporally correlated if they are accessed or queried together during a certain time window) between the columns. The column-based organization program 110a, 110b may track the temporal access patterns by plotting the temporal access pattern of the individual columns, based on the number of accesses (e.g., the number of queries generated for data within a column) to an individual column (y-axis) over a certain time window that the data arrives (x-axis). As such, the column-based organization program 110a, 110b may determine which columns are accessed the most (e.g., most access requests), or during the same time window.

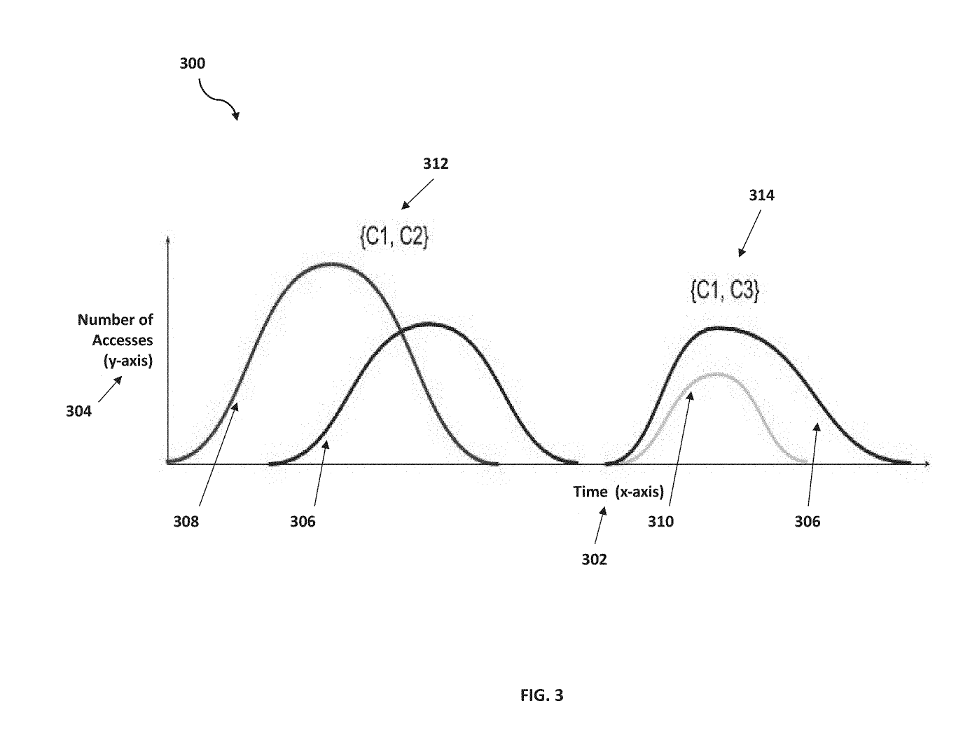

Continuing the previous example, from 8:15 am to 9:15 am, the elevator system obtains multiple queries for the elevator temperature, weight and air quality. The data generated from each of these queries are organized into individual columns. During the time window of 8:15 am to 9:15 am, the data for elevator temperature is organized into column 1 (C1), data for air quality is organized into column 2 (C2) and data for elevator weight is organized into column 3 (C3). The column-based organization program 110a, 110b then plots the data related to the time window and the number of accesses for each of these sensors (i.e., temperature, air quality and weight) on a graph to track the temporal access pattern between C1, C2 and C3. The graphical representation of the temporal access pattern of dynamic column families will be described in greater detail below with respect to FIG. 3.

Then, at 206, column families are formed and stored in a key-value store 208 (e.g., database 114). Using a known algorithm, a column family (e.g., a group of at least two columns utilized to create an organization format for columns) may be formed based on the results from the tracking of the temporal access of individual columns. Based on the temporal access patterns, columns that are accessed during the same time window may be grouped together as column families by the column-based organization program 110a, 110b. As such, when one of the columns are accessed, the other columns within the newly formed column family may be accessed simultaneously. The data within the newly formed column families may be timestamped. Then, the column-based organization program 110a, 110b may search through the key-value store 208 to determine whether the newly formed column family already exists. If the newly formed column family does not already exist in the key-value store 208, then the newly formed column families may be stored in the key-value store 208 for future queries.

If, however, the newly formed column family includes input data that already exists in the key-value store 208, then the newly formed column family may be deemed as duplicate data and the newly formed column family may be removed from the column-based organization program 110a, 110b. Additionally, the column family identification may only identify the correlation between the columns and may not dictate the organization in the storage. Therefore, when a given column is correlated with several other columns, only one organization of the columns in the storage may be possible, or the column may be duplicated with the other correlated columns.

Continuing the previous example, based on the number of accesses that each column received during the 8:15 am to 9:15 am time window, the column-based organization program 110a, 110b formed two column families. The first column family included data related to the elevator temperature and air quality (i.e., {C1, C2}), and the second column family included data related to the elevator temperature and the elevator weight (i.e., {C1, C3}). Each piece of data received is timestamped. After performing a search of the key-value store 208, the column-based organization program 110a, 110b determined that the newly formed column families (i.e., {C1, C2} and {C1, C3}) do not already exist in the key-value store 208. Additionally, since the C1 column overlaps, then the column-based organization program 110a, 110b duplicates C1 to form both column families.

Then, at 210, the column family organization is tracked. The column-based organization program 110a, 110b may keep track of the range of record timestamps that are included in a certain column family organization in a table. The table may identify the columns that were accessed simultaneously, the time of data arrival, and the format of the data within the column family. The table may store such information on the column family within the key-value store 208. The table may be utilized to determine which column families were formed for a particular type or piece of data.

Additionally, the generated table may be further utilized to serve queries for records with specific timestamps. As such, for a query received on the input data, the column-based organization program 110a, 110b may search the generated table to determine the appropriate index for the column family in which the column with the corresponding data may be located. Once access is resolved through the use of the generated table, the data may be retrieved from storage in the key-value store 208 during the particular time window. Otherwise, data may be retrieved from the memory of the computer, or another pre-determined storage mechanism. The generated table may be maintained for the lifetime of the key-value store 208, or other alternative storage system.

Continuing the previous example, as data is generated for each of the column families, {C1, C2} and {C1, C3}, the column-based organization program 110a, 110b continues to keep track of the column families by generating a table. The following table includes the data arrival time window for column families {C1, C2} and {C1, C3}:

| Data Arrival Time Window | Column Families |
|---|---|
| t0 → t1 | {C1, C2} |
| t1 → t2 | {C1, C3} |

As shown in the above table, the data arrives from 8:15 am to 8:40 am (t0→t1) for column family {C1, C2}, and data arrives from 8:40 am to 9:10 am (t1→t2) for column family {C1, C3}.

Then, at 212, the column families are periodically dissolved into individual columns. Due to new input data, the formed column families may no longer be accessed together, and therefore, retaining the formed column family may no longer be practical for the column-based organization program 110a, 110b. As such, depending on the age of the data in the column family, the column-based organization program 110a, 110b may periodically dissolve the column families to re-evaluate the column family organization and to determine whether there may be changes or differences in the temporal access pattern for the column family.

Continuing the previous example, except for the 8:15 am to 9:15 am time window, the temporal access pattern between the elevator temperature and air quality, and the elevator temperature and elevator weight changes in which a query may be received for elevator temperature with no simultaneous query for elevator weight or air quality. As such, the number of accesses to the elevator temperature are not directly correlated to the elevator weight and the air quality, outside of the 8:15 am to 9:15 am time window. The column families of {C1, C2} and {C1, C3} are then dissolved, since the temporal access patterns may no longer be applicable for another time window.

In the present embodiment, the column families may be identified based on the number of queries generated for data within an individual column within a certain time window. Therefore, individual columns with similar temporal access patterns may be identified and organized together into a column family for easier access for future queries.

Referring now to FIG. 3, a diagram of the temporal access pattern of dynamic families represented by the column-based organization program 110a and 110b according to at least one embodiment in 204 is depicted. As shown, time is plotted on the x-axis 302 and the number of accesses is plotted on the y-axis 304 of the graph 300. The column-based organization program 110a, 110b utilizes the received data associated to the time and number of accesses for each of the column families (e.g., {C1, C2} 312 and {C1, C3} 314), and plots each piece of associated data on the graph. Each of the data points are connected to generate a wave for each of the individual columns. The greater the number of accesses on the scale during a certain time window, the higher the height of the wave, and the lower the number of access on the scale during a certain time window, the shorter the height of wave.

The column-based organization program 110a, 110b may generate a graph to keep track of the temporal access pattern for individual columns for the reactive identification of column families. In FIG. 3, the temporal access patterns of the previously formed column families, {C1, C2} 312 and {C1, C3} 314, are tracked by the column-based organization program 110a, 110b.

Each wave may represent a column (e.g., 306, 308, 310). Since data from 306 and 308 were accessed simultaneously, the column family 312 was formed by the column-based organization program 110a, 110b. Similarly, since data from 306 and 310 were accessed in tandem, the column family 314 was formed by the column-based organization program 110a, 110b.

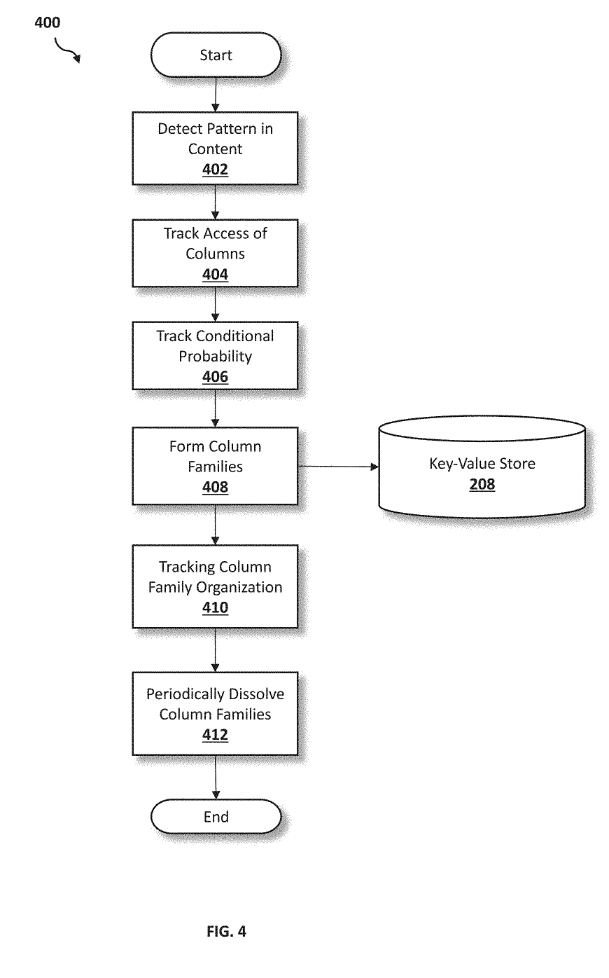

Referring now to FIG. 4, an operational flowchart illustrating the exemplary proactive identification of column families process 400 used by the column-based organization program 110a and 110b according to at least one embodiment is depicted.

At 402, a distinct content pattern is detected in the data. For incoming data, the column-based organization program 110a, 110b may detect a pattern in the content utilizing known clustering algorithms. The clustering algorithms may vary and may be utilized to determine whether certain data changes (e.g., increase or decrease in value) in tandem. If certain data changes in tandem, then the column-based organization program 110a, 110b may determine that a pattern (e.g., relationship) exists between the data.

For example, a smart home monitoring system utilizes system of sensors to control the temperature, lights and motion associated with a user's house. When each sensor associated with the smart home monitoring system is activated, the activated sensors generate data that is transmitted to the column-based organization program 110a, 110b. During the summer months between 5 pm and 6 pm on weekdays, the home alarm system is deactivated around the same time that the front hallway lights, the central air conditioning system and the motion sensor in the front of the house are activated. During the time window between 5 pm and 6 pm, the sensors related to the lights, motion, and central air conditioning system (i.e., temperature) are accessed multiple times. As such, the column-based organization program 110a, 110b detects a distinct content pattern with the data (i.e., lights, temperature and motion) based on the number of accesses during the 5 pm to 6 pm time window.

Next at 404, temporal access of individual columns is tracked by the column-based organization program 110a, 110b. Once a distinct content pattern is identified, the column-based organization program 110a, 110b may organize each field of the data into individual columns. The temporal access of individual columns may be tracked by the column-based organization program 110a, 110b to establish the temporal correlation between the columns for identifying the column families. The column-based organization program 110a, 110b may track the temporal access patterns by plotting the temporal access pattern of the individual columns, based on the number of accesses (e.g., the number of queries generated for data within a column) to an individual column (y-axis) over a certain time window that the data arrives (x-axis). As such, the column-based organization program 110a, 110b may determine which columns are accessed the most (e.g., most access requests), or during the same time window.

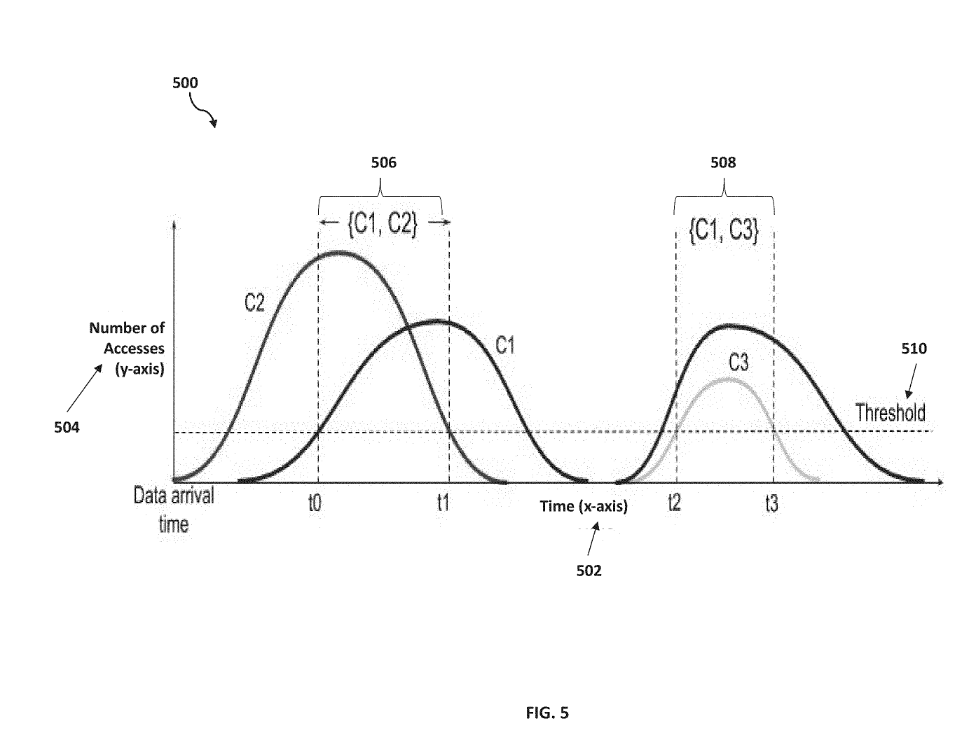

Continuing the previous example, the data generated from each of these events are organized into individual columns. During the time window of 5 pm to 6 pm, data from the light sensors are organized into column 1 (C1), data from the motion sensors are organized into column 2 (C2) and data from the temperature sensors are organized into column 3 (C3). The column-based organization program 110a, 110b then plots the data related to the time window and the number of accesses for each of these sensors (i.e., lights, temperature and motion) on a graph to track the temporal access pattern between C1, C2 and C3. The graphical representation of the temporal access pattern of ephemeral column families will be described in greater detail below with respect to FIG. 5.

Then, at 406, the conditional probability is tracked. The column-based organization program 110a, 110b may identify and keep track of the conditional probability for the occurrence of a content pattern (e.g., confidence value ranging from 0 to 1) and the corresponding column correlation. The conditional probability may be utilized to determine how confident the column-based organization program 110a, 110b is that a specific content pattern correlates with a specific data access pattern. The conditional probability may be determined by known algorithms that utilize the temporal access pattern of the received data and the co-occurrence of a particular content pattern.

Additionally, a threshold may be generated for the conditional probability in which data that falls below the threshold conditional probability may be excluded from creating a column family, since the low conditional probability may adversely affect the performance of the column-based organization program 110a, 110b. The threshold conditional probability may be defined by the database administrator as a database configuration parameter, which may immediately affect incoming data to the column-based organization program 110a, 110b.

If, however, the database administrator fails to define the threshold conditional probability, then the column families may be formed based on weak temporal correlation between the individual columns. As such, even though such weak correlations may not affect the accuracy of the column families formed, the performance of the column-based organization program 110a, 110b may be adversely impacted.

Continuing the previous example, the column-based organization program 110a, 110b utilizes a known algorithm to determine the conditional probability for the detected content pattern such that each of the sensors (i.e., lights, temperature and motion) will be accessed simultaneously in future queries. As such, the conditional probability for lights (C1) and temperature (C3) is 0.3, lights (C1) and motion (C2) is 0.7, and motion (C2) and temperature (C3) is 0.19.

Additionally, the database administrator generated a threshold for the conditional probability prior to the receipt of the incoming data. The threshold was pre-defined as 0.25. A content pattern with a conditional probability of 0.25 or less may be excluded from creating a column family. Since motion (C2) and temperature (C3) generated a conditional probability of 0.19, which is less than the threshold of 0.25, the content pattern for the data in motion (C2) and temperature (C3) will not be utilized to form a column family between C2 and C3 for the smart home monitoring system during the 5 pm to 6 pm time window.

Then, at 408, column families are formed and stored in a database (e.g., key-value store 208). A column family may be formed based on an occurrence of a tracked content pattern. Based on the tracked content patterns and the conditional probability values, columns that form a distinct content pattern, with conditional probability values that satisfy the threshold, may be grouped together as column families by the column-based organization program 110a, 110b. As such, when one of the columns is accessed, the other columns within the newly formed column family may be accessed simultaneously. The data within the newly formed column families may be timestamped. Then, the column-based organization program 110a, 110b may search through the key-value store 208 to determine whether the newly formed column family already exists. If the newly formed column family does not already exist in the key-value store 208, then the newly formed column families may be stored in the key-value store 208 for future queries.

If, however, a column family with the same data already exists in the key-value store 208, then the newly column family may be deemed as duplicate data and may be removed from the column-based organization program 110a, 110b. Additionally, the column family identification may only identify the correlation between the columns and may not dictate the organization in the storage. Therefore, when a given column is correlated with several other columns, only one organization of the columns in the storage may be possible, or the column may be duplicated with the other correlated columns.

Continuing the previous example, based on the detected content pattern, two column families are formed. The two column families include data from the light sensors (C1) and motion sensors (C2), and data from the light sensors (C1) and the temperature sensors (C3). As such, whenever data is accessed related to the lights, data related to the motion sensors or temperature sensors may be accessed as well. Additionally, the column-based organization program 110a, 110b timestamped the data within the column families, and searched the key-value store 208 to determine whether there were other column families for {C1, C2} and {C1, C3}. Since no other same column families exists in the key-value store 208, the column families and their data are stored in the key-value store 208. Furthermore, since the C1 column overlaps, then the column-based organization program 110a, 110b duplicates C1 to form both column families.

Then, at 410, the column family organization is tracked. The column-based organization program 110a, 110b may utilize a table to keep track of the range of record timestamps for column families. The table may identify the columns that were accessed simultaneously, the conditional probability values of each column family, and the time of data arrival and the format of the data within the column family. The table may store such information on the column family within the key-value store 208. The table may be utilized to determine which column families were formed for a particular type or piece of data.

Additionally, the generated table may be further utilized to serve queries for records with specific timestamps. As such, for a query received on the input data, the column-based organization program 110a, 110b may search the generated table to determine the particular index of the column family in which the column with the corresponding data may be located.

Continuing the previous example, as data is generated for each of the column families, {C1, C2} and {C1, C3}, the column-based organization program 110a, 110b continues to keep track of the column families by generating a table. The following table includes the content pattern, column family, time frame and the conditional probability for {C1, C2} and {C1, C3}:

| | | | Conditional |
|---|---|---|---|
| Content Patten | Column Family | Time Frame | Probability |
| P1 | {C1, C2} | t0 → t1 | 0.7 |
| P2 | {C1, C3} | t2 → t3 | 0.3 |

As shown in the above table, the {C1, C2} content pattern (P1) is generated from 5 pm (t0) to 5:20 pm (t1) and has a previously determined conditional probability of 0.7. The {C1, C3} content pattern (P2) is generated from 5:35 pm (t2) to 5:50 pm (t3) and has a previously determined conditional probability of 0.3.

Then, at 412, the column families are periodically dissolved into individual columns. Depending on the time interval configuration parameter defined by the database administrator, the column-based organization program 110a, 110b may periodically dissolve the formed column families. Due to potential changes in the content pattern, the formed column families may no longer be accessed together, and therefore, retaining the formed column family may no longer be practical for the column-based organization program 110a, 110b. As such, the column-based organization program 110a, 110b may periodically dissolve the column families to re-evaluate the column family organization and to determine whether there may be changes or differences in the content pattern for the column family.

Continuing the previous example, after the 5 pm to 6 pm time window, the content pattern between the lights and motion sensors, and the lights and temperature sensors changes in which the motion sensors are activated regardless of whether the lights are activated, and the temperature continues to decrease regardless of whether the lights are activated. As such, the number of accesses to the light sensors are not directly correlated to the motion sensors and the temperature sensors outside of that time window. The column families of {C1, C2} and {C1, C3} are then dissolved to re-assess the correlation between the individual columns.

In the present embodiment, with the proactive identification of column families, the column families may be identified before queries are run on the data. Since changes in the content pattern may affect the query that runs on the data, the column families may be identified by the content pattern of the incoming data.

Referring now to FIG. 5, a diagram of the temporal access pattern of ephemeral families used by the column-based organization program 110a and 110b according to at least one embodiment in 404 is depicted. As shown, time is plotted on the ephemeral x-axis 502 and the number of accesses is plotted on the ephemeral y-axis 504 of the graph 500. The column-based organization program 110a, 110b utilizes the received data associated with the certain time window (e.g., t0→t1 and t2→t3) and number of accesses that each of the represented individual columns (e.g., C1, C2, C3), and plots each piece of associated data on the graph. Each of the data points are connected to generate a wave for each of the individual columns.

In FIG. 5, the time windows 506 and 508 capture the greatest number of accesses for each column to determine the appropriate column family (e.g., {C1, C2} and {C1, C3}). The greater the number of accesses on the scale during a certain time window, the higher the height of the wave, and the lower the number of access on the scale during a certain time window, the shorter the height of wave.

Additionally, the graph 500 may include a threshold 510 based on the conditional probability as indicated by the dotted line parallel to the x-axis. Data that falls below the threshold 510 conditional probability may be excluded from creating a column family, since the low conditional probability may adversely affect the data and the column families formed.

The generated graph 500 may be utilized by the column-based organization program 110a, 110b to identify the temporal access pattern for individual columns for the proactive identification of column families. In FIG. 5, based on the generated data, the column-based organization program 110a, 110b detects a temporal access pattern between the individual columns of C1 and C2, and the individual columns of C1 and C3, and therefore, generates two column families (e.g., {C1, C2} and {C1, C3}).

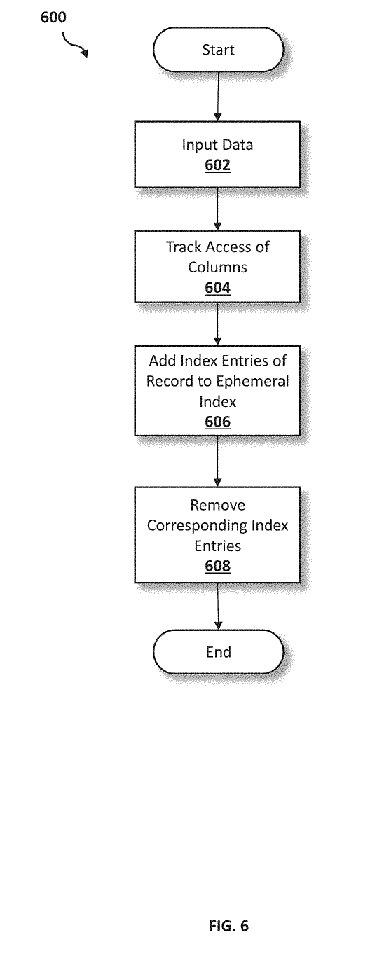

Referring now to FIG. 6, an operational flowchart illustrating the exemplary storing and indexing column families process 600 used by the column-based organization program 110a and 110b according to at least one embodiment is depicted.

At 602, input data arrives into the key-value store 208. The input data may include data records (e.g., data with several fields and timestamp) from the individual columns retrieved from either the reactive identification of column families, or the proactive identification of column families.

For example, data associated with the light, motion and temperature sensors from the smart home monitoring system arrives from the proactive identification of column families to the key-value store 208.

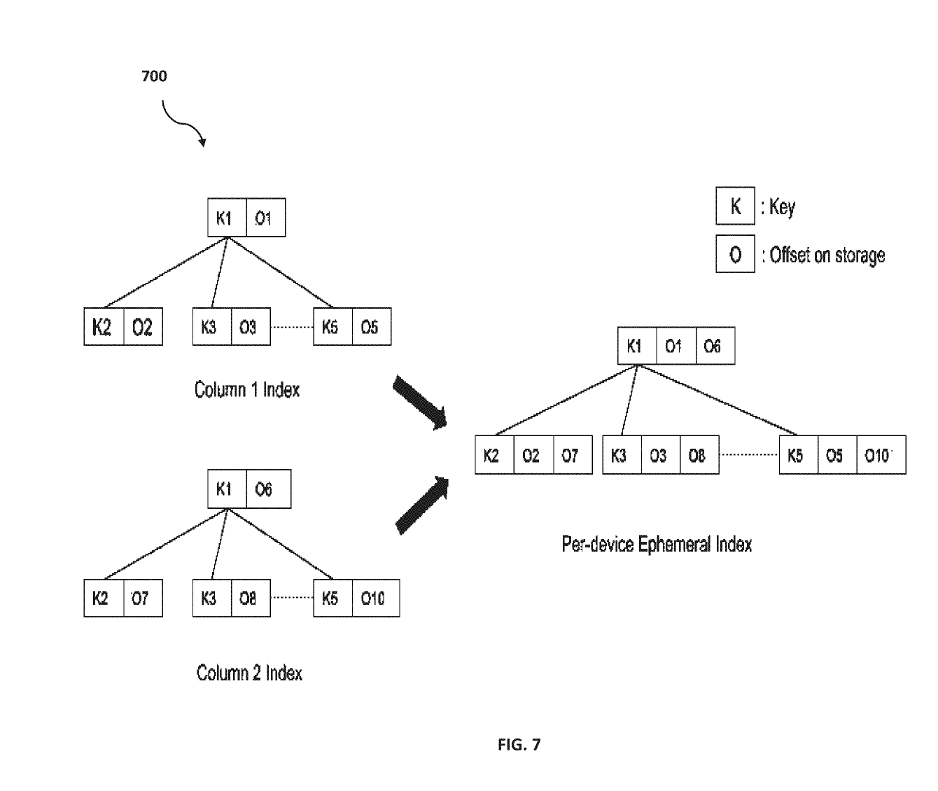

Next, at 604, temporal access of individual columns is recorded by the column-based organization program 110a, 110b. When the data arrives, the data may be converted into individual columns. For the lifespan of the data record in the key-value store 208, the temporal access of individual columns may be identified and tracked by the column-based organization program 110a, 110b to establish an access-based temporal correlation of the columns in each time window. Each column is indexed using data structures, such as Height Balanced m-way Search Trees (e.g., B-trees), which is an organizational structure for storage and retrieval in the form of a self-balanced search tree with multiple keys in every node and more than two children for every node. The formation of the B-trees for the individual columns in the key-value store 208 will be described in greater detail below with respect to FIG. 7.

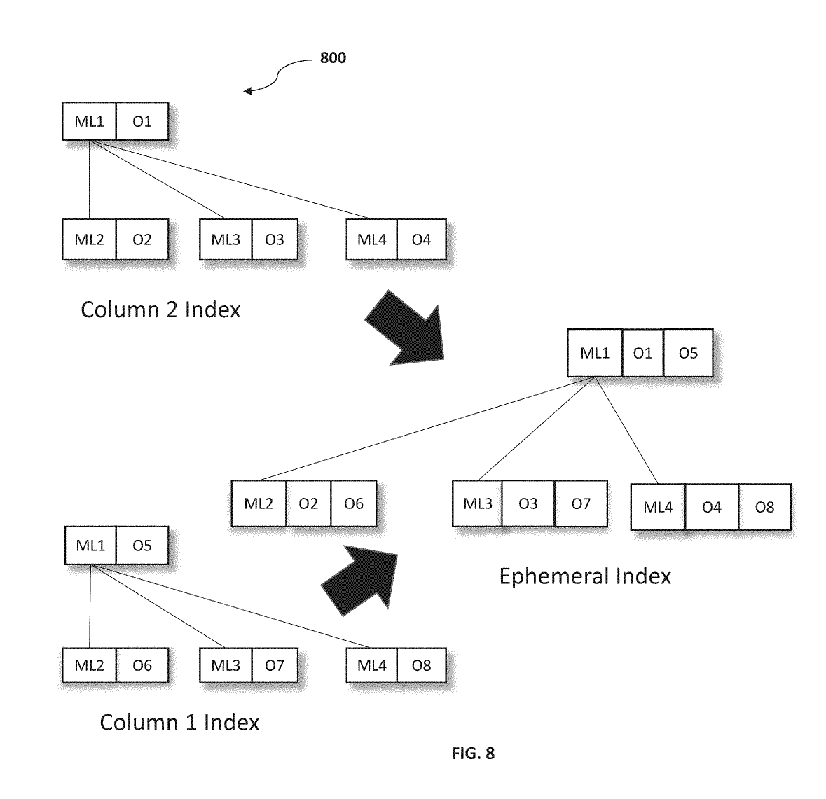

Continuing the previous example, upon arrival, the data records are converted into individual columns. The data records related to the light sensors within the smart home monitoring system are utilized to a create column 1 index, and the data records related to the motion sensors within the smart home monitoring system are utilized to create a column 2 index. Then, the column-based organization program 110a, 110b tracks the temporal access patterns of the individual columns. Each column is indexed in separate B-trees that are later used to form an ephemeral index. The formation of an ephemeral index related to the light and motion sensors of the smart home monitoring system in the key-value store 208 will be described in greater detail below with respect to FIG. 8.

Then, at 606, index entries of records are added to the ephemeral index. When the age of a data record in the key-value store 208 reaches the identified time window, the index entries of the data record may be added into the ephemeral index. An index entry may be created for each data record as it arrives from the external data source. By subtracting the timestamp from the current time, the column-based organization program 110a, 110b may determine the age of the data record. The time window may be based on the age of the data record, which may be applied to the indexes. The addition of the corresponding indexes into an ephemeral index in the key-value store 208 will be described in greater detail below with respect to FIG. 7.

Additionally, the generated ephemeral index may be further utilized to serve queries for records that are within a certain time window. As such, for a query received on the input data, the column-based organization program 110a, 110b may search the generated ephemeral index to determine the particular index of the column family in which the column with the corresponding data may be located, or whether a newly formed column family may be a duplicate of a previously formed column family formed and stored in the key-value store 208.

When the age of the ingested data records reaches the identified time window, the corresponding nodes in the column 1 and column 2 indexes are added into the ephemeral index, when that particular time window arrives. Prior to adding the column 1 and column 2 indexes, the column-based organization program 110a, 110b determines that the age of the data record within the column 1 and column 2 indexes correspond with the identified time window. The addition of the column 1 and 2 indexes related to the light and motion sensors of the smart home monitoring system into the ephemeral index will be described in greater detail below with respect to FIG. 8.

If, however, the column-based organization program 110a, 110b determines that the age of the data record within the column 1 and column 2 indexes fail to correspond with the identified time window, then the column 1 and column 2 indexes would not be added to the ephemeral index.

Then, at 608, the corresponding index entries are removed. When the age of a data record in the key-value store 208 exceeds the identified time window, the corresponding index entries may be removed from the ephemeral index.

Continuing the previous example, since the age of the data records for the motion and light sensors in the smart home monitoring system exceeded the pre-defined one hour time window, the ephemeral index was dissolved and column 1 and column 2 index entries were removed from the ephemeral index. The individual columns (i.e., column 1 and column 2) remain in separate individual indexes (i.e., column 1 index and column 2 index) within the key-value store 208.

In the present embodiment, the correlation between the columns may be transient in which individual columns may obtain access to other individual columns with data from different time window. As such, column families may be modified after formation.

Referring now to FIG. 7, a diagram illustrating the exemplary process for creating an ephemeral index for column families 700 used by the column-based organization program 110a and 110b according to at least one embodiment is depicted. As shown, the ephemeral index (e.g., per-device ephemeral index) is constructed from indexes of constituents organized in the form of B-trees with multiple keys. The leaf nodes are located at the same level, and the non-leaf nodes are located underneath the respective leaf nodes.

In FIG. 7, the constituent indexes include three multiple keys with two leaf nodes (e.g., K1, O1 for column 1 and K1, O6 for column 2) located on the same level. Each key may identify a data record and may be utilized to query the data records. Each K1 includes three child nodes for each of the indexes (e.g., K2, K3, K5 for columns 1 and 2), each of which are connected to respective offsets in storage (e.g., O2, O3, O5 for column 1 and O7, O8, O10 for column 2). Each offset may represent the location of each data record in storage with regards to the beginning of the logical or physical organization of the data.

The nodes of column 1 and 2 indexes may be combined to form one ephemeral index, where the leaf nodes are represented by K1, O1 and O6. The non-leaf nodes include K2 with O2 and O7, K3 with O3 and O8, and K5 with O5 and O10.

In the present embodiment, the ephemeral column families existing with a given time window may have the same number of nodes. The nodes, however, may vary over time as the new records are added to the ephemeral indexes, and the data records aging past the time window may be removed from the ephemeral indexes.

Referring now to FIG. 8, a diagram illustrating the exemplary process for creating an ephemeral index for column families related to motion and light sensors for a smart home monitoring system 800 used by the column-based organization program 110a and 110b according to at least one embodiment is depicted. As shown, the ephemeral index is constructed from indexes of column 1 (e.g., data records for the light sensors) and column 2 (e.g., data records for the motion sensors) organized in the form of B-trees with multiple keys. The leaf nodes are located at the same level, and the non-leaf nodes are located underneath the respective leaf nodes.

In FIG. 8, the column 1 index includes one key with two leaf nodes (e.g., ML1, O5). The key is represented by ML1 and the O5 is the offset storage for the data records included in the respective key. ML1 includes three child nodes for each of the indexes (e.g., ML2, ML3, ML4) each of which are connected to respective offsets in storage (e.g., O6, O7, O8).

Similar to the column 1 index, the column 2 index includes one key with two leaf nodes (e.g., ML1, O1). The key is represented by ML1 and the O1 is the offset storage for the data records included in the respective key. ML1 includes three child nodes for each of the indexes (e.g., ML2, ML3, ML4) each of which are connected to respective offsets in storage (e.g., O2, O3, O4).

The nodes of column 1 and 2 indexes may be combined to form one ephemeral index, where the leaf nodes are represented by ML1, O1 and O5. The non-leaf nodes include ML2 with O2 and O6, ML3 with O3 and O7, and ML4 with O4 and O8.

It may be appreciated that FIGS. 2-8 provide only an illustration of one embodiment and do not imply any limitations with regard to how different embodiments may be implemented. Many modifications to the depicted embodiment(s) may be made based on design and implementation requirements.

FIG. 9 is a block diagram 900 of internal and external components of computers depicted in FIG. 1 in accordance with an illustrative embodiment of the present invention. It should be appreciated that FIG. 9 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 9. Each of the sets of internal components 902 a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the column-based organization program 110a in client computer 102, and the column-based organization program 110b in network server 112, may be stored on one or more computer-readable tangible storage devices 916 for execution by one or more processors 906 via one or more RAMs 908 (which typically include cache memory). In the embodiment illustrated in FIG. 9, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the column-based organization program 110a and 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless Wi-Fi interface cards, or 3G or 4G wireless interface cards or other wired or wireless communication links. The software program 108 and the column-based organization program 110a in client computer 102 and the column-based organization program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the column-based organization program 110a in client computer 102 and the column-based organization program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

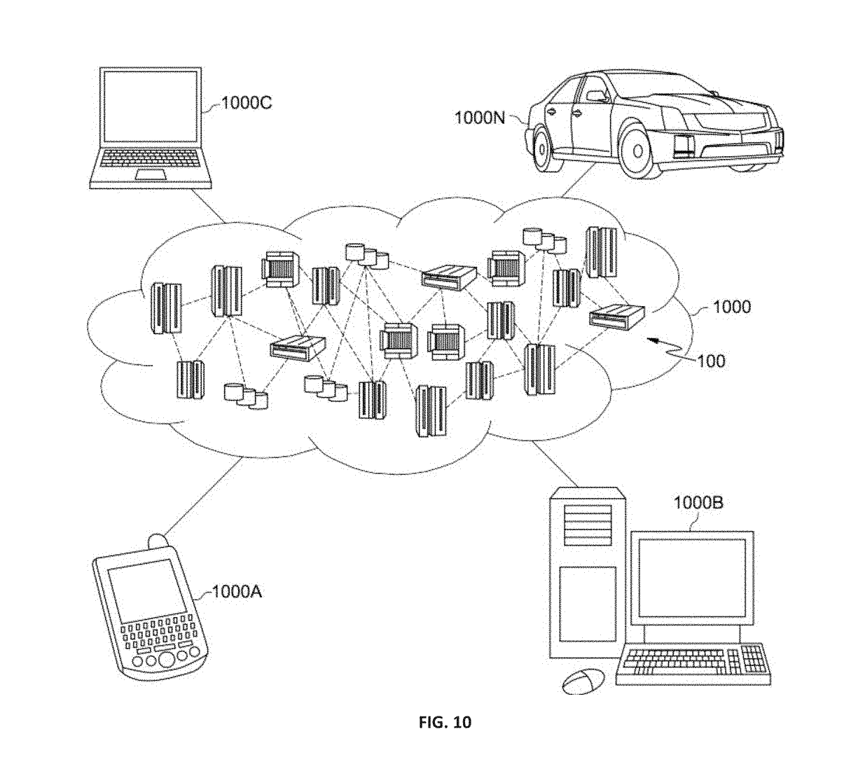

Referring now to FIG. 10, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 10 are intended to be illustrative only and that computing nodes 100 and cloud computing environment 1000 can communicate with any type of computerized device over any type of network and/or network addressable connection (e.g., using a web browser).

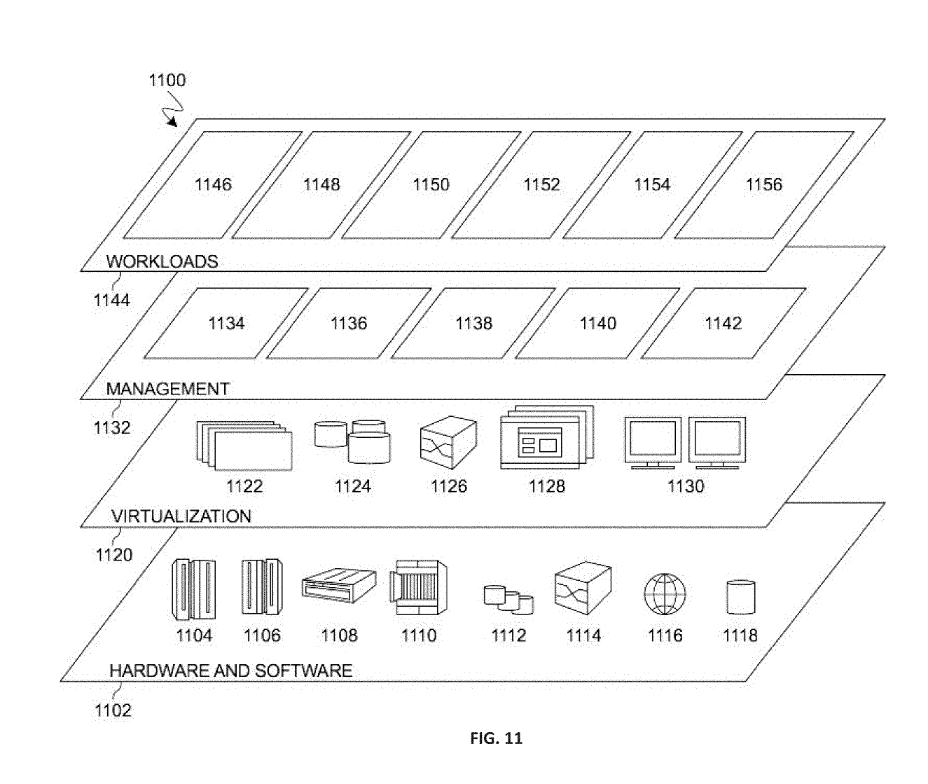

Referring now to FIG. 11, a set of functional abstraction layers 1100 provided by cloud computing environment 1000 is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and column-based organization 1156. A column-based organization program 110a, 110b provides a way to organize column families based on data content.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for organizing a plurality of column families based on data content, the method comprising:
analyzing a plurality of data;
generating a plurality of individual columns based on the analyzed plurality of data;
identifying a plurality of temporal access patterns associated with the generated plurality of individual columns based on the content of the analyzed plurality of data;
forming the plurality of column families based on the identified plurality of temporal access patterns; and
storing the formed plurality of column families in a key-value store.

2. The method of claim 1, further comprising:
tracking the identified plurality of temporal access patterns associated with the formed plurality of column families; and
dissolving the formed plurality of column families to re-assess the correlation between the generated plurality of individual columns.

3. The method of claim 1, wherein analyzing the plurality of data, further comprises:
determining the analyzed plurality of data was received in response to a plurality of access requests; and
analyzing the determined plurality of data to identify the plurality of temporal access patterns based on the determined plurality of access requests to the determined plurality of data.

4. The method of claim 1, wherein analyzing the plurality of data, further comprises:
determining the analyzed plurality of data is based on a plurality of incoming data; and
detecting a plurality of distinct content patterns using clustering algorithms based on the determined plurality of incoming data.

5. The method of claim 4, further comprising:
identifying a plurality of conditional probabilities of the co-occurrence of the detected plurality of distinct content patterns based on the determined plurality of incoming data and the identified plurality of temporal access patterns.

6. The method of claim 5, further comprising:
determining a threshold for the identified plurality of conditional probabilities;
analyzing the formed plurality of column families with the corresponding identified plurality of conditional probabilities based on the determined threshold;
identifying the formed plurality of column families that fail to satisfy the determined threshold; and
removing the formed plurality of column families that fail to satisfy the determined threshold.

7. The method of claim 1, further comprising:
adding the formed plurality of column families to the key-value store;
dissolving the formed plurality of column families into the generated plurality of individual columns;
converting the organized plurality of individual columns into a plurality of index entries;
adding the converted plurality of index entries into a plurality of ephemeral indexes;
determining an age associated with the analyzed plurality of data in the converted plurality of index entries exceeds a time window for the plurality of ephemeral indexes; and
removing the added plurality of the index entries from the corresponding plurality of ephemeral indexes.

8. The method of claim 1, wherein identifying the plurality of temporal access patterns for the generated plurality of individual columns based on the content of the analyzed plurality of data, further comprises:
determining a number of accesses for the generated plurality of individual columns;
determining the time window for an arrival of the analyzed plurality of data corresponding with the generated plurality of individual columns; and
determining the identified plurality of temporal access patterns based on the determined number of accesses associated with the time window for the arrival of the analyzed plurality data corresponding with the organized plurality of individual columns.

9. A computer system for organizing a plurality of column families based on data content, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing a plurality of data;
generating a plurality of individual columns based on the analyzed plurality of data;
identifying a plurality of temporal access patterns associated with the generated plurality of individual columns based on the content of the analyzed plurality of data;
forming the plurality of column families based on the identified plurality of temporal access patterns; and
storing the formed plurality of column families in a key-value store.

10. The computer system of claim 9, further comprising:
tracking the identified plurality of temporal access patterns associated with the formed plurality of column families; and
dissolving the formed plurality of column families to re-assess the correlation between the generated plurality of individual columns.

11. The computer system of claim 9, wherein analyzing the plurality of data, further comprises:
determining the analyzed plurality of data was received in response to a plurality of access requests; and
analyzing the determined plurality of data to identify the plurality of temporal access patterns based on the determined plurality of access requests to the determined plurality of data.

12. The computer system of claim 9, wherein analyzing the plurality of data, further comprises:
determining the analyzed plurality of data is based on a plurality of incoming data; and
detecting a plurality of distinct content patterns using clustering algorithms based on the determined plurality of incoming data.

13. The computer system of claim 12, further comprising:
identifying a plurality of conditional probabilities of the co-occurrence of the detected plurality of distinct content patterns based on the determined plurality of incoming data and the identified plurality of temporal access patterns.

14. The computer system of claim 13, further comprising:
determining a threshold for the identified plurality of conditional probabilities;
analyzing the formed plurality of column families with the corresponding identified plurality of conditional probabilities based on the determined threshold;
identifying the formed plurality of column families that fail to satisfy the determined threshold; and
removing the formed plurality of column families that fail to satisfy the determined threshold.

15. The computer system of claim 9, further comprising:
adding the formed plurality of column families to the key-value store;
dissolving the formed plurality of column families into the generated plurality of individual columns;
converting the organized plurality of individual columns into a plurality of index entries;
adding the converted plurality of index entries into a plurality of ephemeral indexes;
determining an age associated with the analyzed plurality of data in the converted plurality of index entries exceeds a time window for the plurality of ephemeral indexes; and
removing the added plurality of the index entries from the corresponding plurality of ephemeral indexes.

16. The computer system of claim 9, wherein identifying the plurality of temporal access patterns for the generated plurality of individual columns based on the content of the analyzed plurality of data, further comprises:
determining a number of accesses for the generated plurality of individual columns;
determining the time window for an arrival of the analyzed plurality of data corresponding with the generated plurality of individual columns; and
determining the identified plurality of temporal access patterns based on the determined number of accesses associated with the time window for the arrival of the analyzed plurality data corresponding with the organized plurality of individual columns.

17. A computer program product for organizing a plurality of column families based on data content, comprising:
one or more computer-readable storage media and program instructions stored on at least one of the one or more tangible storage media, the program instructions executable by a processor to cause the processor to perform a method comprising:
program instructions to analyze a plurality of data;
program instructions to generate a plurality of individual columns based on the analyzed plurality of data;
program instructions to identify a plurality of temporal access patterns associated with the generated plurality of individual columns based on the content of the analyzed plurality of data;
program instructions to form the plurality of column families based on the identified plurality of temporal access patterns; and
program instructions to store the formed plurality of column families in a key-value store.

18. The computer program product of claim 17, further comprising:
program instructions to track the identified plurality of temporal access patterns associated with the formed plurality of column families; and
program instructions to dissolve the formed plurality of column families to re-assess the correlation between the generated plurality of individual columns.

19. The computer program product of claim 17, wherein program instructions to analyze the plurality of data, further comprises:
program instructions to determine the analyzed plurality of data was received in response to a plurality of access requests; and
program instructions to analyze the determined plurality of data to identify the plurality of temporal access patterns based on the determined plurality of access requests to the determined plurality of data.

20. The computer program product of claim 17, wherein program instructions to analyze the plurality of data, further comprises:
program instructions to determine the analyzed plurality of data is based on a plurality of incoming data; and
program instructions to detect a plurality of distinct content patterns using clustering algorithms based on the determined plurality of incoming data.
